(19) United States
(12) Patent Application Publication
(10) Pub. No.: US 2008/0030323 A1
(43) Pub. Date: Feb. 7, 2008

(54) DEVICE AND METHOD FOR ASCERTAINING THE GEOGRAPHIC POSITION OF A PERSON

(75) Inventor: Jochen Katzer, Bergtshofen (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Navigon AG, Hamburg (DE)

(21) Appl. No.: 11/780,631

(22) Filed: Jul. 20, 2007

(30) Foreign Application Priority Data
Aug. 2, 2006 (DE) 10 2006 036 375.2

(51) Int. Cl. H04Q 7/00

(52) U.S. Cl. 340/539.13

(57) ABSTRACT

The present invention relates to a configuration and a method for localizing the geographic position of a person. The localization configuration comprises a transmission unit (5, 6, 7) connectable to the person, as well as a reception unit (1) for displaying the location of the person.

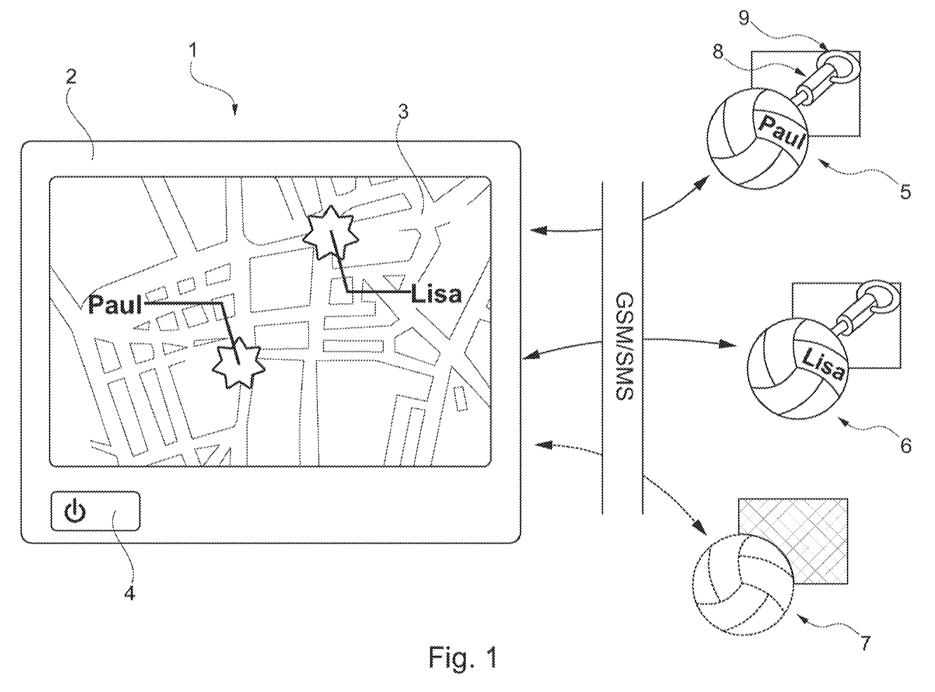

The present invention is distinguished in that the transmission unit (5, 6, 7) comprises a GPS receiver and is connectable via wireless communication to the reception unit (1). The present invention allows both high precision in localization and also position ascertainment over great distances. The method and the cost-effectively producible device may also be used by lay people easily.

### CROSS-REFERENCE TO RELATED APPLICATIONS

The present patent application claims priority from German Patent Application No. DE 10 2006 036 375.2, filed on Aug. 2, 2006. The present invention relates to a device for ascertaining the geographic position of a person according to claim 1, as well as a method for ascertaining the geographic position of a person according to claim 18.

### BACKGROUND OF THE INVENTION

Devices and methods for ascertaining the geographic position of individuals are advantageously used when individuals—for example, but in no way exclusively, for security reasons—are to be localized at a distance. Known devices and methods for localizing individuals are based, for example, on the principle of radio direction finding, a radio transmitter connected to the person being localized at a distance using a corresponding directional receiver.

The localization of individuals using radio transmitters and directional receivers is extremely complex, however, and, in addition, sufficient precision is often not achieved.

Furthermore, the localization of individuals using directional receivers requires a direct radio link between the radio transmitter and the directional receiver, which is problematic depending on the type of landscape and with increasing distance between radio transmitter and directional receiver. Finally, the handling of the complicated apparatuses required for this purpose demands special professional knowledge and may therefore only be executed by trained specialists, which is associated with comparatively high costs.

The localization of individuals using the known technology of radio direction finding therefore suggests itself only for short distances and for special areas of use. Broad use, in particular also by lay people or end-users—for example, ascertaining the current location of children by their parents—is therefore practically precluded by the apparatuses and methods known from the prior art.

### SUMMARY OF THE INVENTION

With this background, it is the object of the present invention to provide a device and a method for ascertaining the geographic position of individuals, using which the cited disadvantages present in the prior art may be overcome. In particular, both high precision of the localization and also position ascertainment over long distances are to be made possible by the present invention; the method and the device are also to be usable by anyone easily and with the least possible effort, while simultaneously having great flexibility, and are also to be producible cost-effectively on the product side.

This object is achieved by a configuration according to claim 1 and by a method having the features of claim 17.

Preferred embodiments are the subject matter of the subclaims.

The device or configuration according to the present invention is used for ascertaining the geographic position of at least one person. For this purpose, the configuration comprises, in a way initially assumed to be known per se, a battery-powered transmission unit connectable to the person, as well as a reception unit for displaying the geographic position of the person.

According to the present invention, however, the configuration is distinguished in that the transmission unit comprises a satellite locating receiver, such as a GPS receiver or Galileo receiver, and is connectable via wireless communication to the reception unit.

This is particularly advantageous because in this way the actual ascertainment of the precise position of the transmission unit and/or the person to be localized no longer has to be performed complexly and often with inadequate precision and reliability by the reception unit, but rather is performed by the transmission unit connected to the person to be localized.

The position of the person to be localized, which is ascertained by the transmission unit with practically arbitrary precision, is then transmitted via wireless communication from the transmission unit to the reception unit, and solely still has to be displayed there.

A further advantage of the configuration according to the present invention is thus also that in contrast to the prior art, no direct connection to the reception unit, much less a radio link capable of direction finding, is necessary for the actual position determination. The position ascertained by the transmission unit solely has to be transmitted in a suitable way wirelessly to the reception unit, for which manifold suitable communication pathways exist, however.

Therefore, the implementation of the present invention is primarily independent of the communication technology actually used between transmission unit and reception unit, as long as the communication technology used allows synchronous and secure transmission, in particular of the position data, between transmission unit and reception unit.

According to an especially preferred embodiment of the present invention, however, the wireless communication between transmission unit and reception unit is performed as data exchange via SMS text messages. The communication between transmission unit and reception unit via the exchange of SMS messages is distinguished in particular by cost-effectiveness and high reliability. An essential advantage of the use of existing mobile wireless networks having the SMS transmission pathways provided therein is that the transmission power of the transmission unit may be kept uniformly low independently of the distance between transmission unit and reception unit. This is because, thanks to the radio cells and the infrastructure background of the particular mobile wireless network, no direct wireless link is needed between transmission unit and reception unit. Alternatively to the direct communication between transmission unit and reception unit via SMS text messages, indirect communication may also be provided. For this purpose, the geographic position may be stored on a server via GPRS data exchange. The position may then be retrieved later from the server.

The data exchange between transmission unit and reception unit via SMS messages is also advantageous because temporary inability to reach the transmission unit or the reception unit does not impair the data transmission, because the infrastructure of the mobile wireless network ensures that an SMS message which is currently not deliverable is transmitted multiple times until the successful delivery at the receiver is reported.

In particular with this background, according to a further preferred embodiment of the present invention, the transmission unit and/or the reception unit of the localization configuration according to the present invention contains a standardized GSM or CDMA module, i.e., provided in the form of an integrated circuit, and/or the transmission unit contains a standardized GPS module.

The use of standardized and/or integrated GSM, CDMA, and/or GPS modules is advantageous because in this way transmission unit and reception unit may be executed especially cost-effectively and compactly as well as reliably and with low power consumption.

According to a further embodiment of the present invention, the transmission unit, in addition to position determination via satellite locating, is additionally set up for position determination via the particular GSM radio cell. This embodiment is advantageous because in this way approximate location determination of the transmission unit may still be performed in the meaning of redundancy, even if satellite locating is not possible under specific boundary conditions.

The latter may be the case, for example, if the person to be localized, who has the transmission unit, is located in a building, in a motor vehicle, or at another location at which there is no or only restricted visual contact with the locating satellite. In such a case the transmission unit may still be assigned—with reduced precision—without problems to the radio cell of the mobile wireless network in which it is currently located.

According to a further, especially preferred embodiment of the present invention, the transmission unit has a housing which may not be opened or may only be opened with special tools. The transmission unit is preferably set up in such a way that an emergency call is placed in case of unauthorized opening of the housing of the transmission unit. These embodiments are particularly advantageous in regard to manipulation security of the transmission unit, and in regard to vandalism security and kidnapping protection.

Moreover, in a further embodiment of the present invention, the transmission unit has permanently integrated user identification. A permanently integrated user identification-which may comprise a SIM card permanently installed in the transmission unit or another telephone number or ID number permanently assigned to the transmission unit, for example—has the advantage that the transmission unit may obtain an especially simple, closed construction in this way.

With a similar background, according to a further, especially preferred embodiment of the present invention, the transmission unit and/or the reception unit has an induction apparatus for contactless charging of a battery of the transmission unit and/or the reception unit. This offers the advantage, which is particularly relevant in regard to the transmission unit, that the housing may be implemented as hermetically sealed and closed. Thus, for example, the housing halves of the transmission unit may be permanently welded or tightly and solidly glued to one another in this embodiment of the present invention.

According to a further embodiment of the present invention, the transmission unit is set up for clearly visible identification using the name of the person to be localized. This is advantageous because the transmission unit may be assigned easily and rapidly to a person in this way, in particular in the case of multiple transmission units assigned to one reception unit. In the exemplary case of a family having multiple children, the particular transmission unit assigned to one child may be differentiated rapidly and reliably from another transmission unit which is assigned to another child; and therefore, confusions in the localization of the children may be avoided.

According to a further embodiment of the present invention, the transmission unit is exclusively set up for communication with the assigned reception unit. This embodiment also particularly serves for manipulation security, because in this way the person to be localized may exclusively be localized via the assigned reception unit, but not via other reception units, even if third parties know the identification, the ID number, or the telephone number of the transmission unit.

In regard to redundancy, in particular in the event of a possible breakdown of the reception unit, according to an alternative embodiment of the present invention, the transmission unit—in addition to the localizing commands of the assigned reception unit—also accepts localizing commands of a further reception unit. In particular, an emergency call center, and/or a service center of the manufacturer or of a mobile wireless operator, comes into consideration as a further reception unit whose localizing commands are accepted by the transmission unit.

According to a further embodiment of the present invention, the transmission unit and/or the reception unit of the localizing configuration each represent a mobile telephone. In this way, advantageous functional unification of multiple apparatuses may be achieved; therefore, in this embodiment of the present invention, in addition to the localizing function, bidirectional speech communication is additionally possible via the same apparatus.

According to a further embodiment of the present invention, the transmission unit is detachably connected to a fastener, for example, to a carabiner or key ring. The fastener is used for stable connection of the transmission unit, in particular to the clothing of the person to be localized. Thanks to the detachable connection between transmission unit and fastener, the transmission unit may be connected easily and rapidly to the clothing of the person to be localized, and the transmission unit may also be easily removed from the clothing again, in particular for the purpose of the charging procedure of the transmission unit.

Alternatively, the transmission unit is additionally set up to place an emergency call in case of removal of the transmission unit from the fastener. In other words, this means that in case of unauthorized removal of the transmission unit from the person to be localized—in the meaning of manipulation or kidnapping protection—an emergency call is immediately placed to the reception unit by the transmission unit.

According to a further embodiment of the present invention, the localizing configuration comprises a transponder unit connectable directly to the body of the person to be localized. The transponder unit is connectable to the transmission unit via wireless communication. Simultaneously, the transmission unit is set up in such a way that in case of interruption of the communication between transponder unit and transmission unit—for example, in the event of impermissible increase of the distance between transmission unit and transponder unit—an emergency call may be placed to the reception unit.

In this way, still further improved manipulation and/or kidnapping security may be achieved, because in the event of unauthorized removal of the transmission unit from the person to be localized, the triggering of the emergency call thus occurs with great security and reliability.

With the same background, according to a further embodiment of the present invention—for further improvement of the manipulation security—the transponder unit may be introduced into the body of the person, and/or is unremovably connectable to the body of the person. Thus, it is particularly conceivable that a miniaturized transponder unit—by injection under the skin, by swallowing, in the form of a tooth filling, by gluing to a tooth or fingernail, or the like—is temporarily or permanently connected unremovably to the body of the person to be localized. In this way, practically complete manipulation security may be achieved, and/or secure triggering of the alarm may be ensured for the case of unauthorized removal of the transmission unit from the person to be localized.

Furthermore, the present invention relates to a method for ascertaining the geographic position of a person using a transmission unit and a reception unit. The transmission unit comprises a satellite locating receiver and the transmission unit comprises an apparatus for displaying the geographic position of the person.

In the scope of the method according to the present invention, in a first method step a), the command for localizing the person is input into the reception unit.

In a further method step b), the reception unit wirelessly transmits the localizing command to the transmission unit assigned to the person to be localized.

Subsequently, in a further method step c), the current geographic position of the transmission unit—and/or of the person to be localized—ascertained by the transmission unit is wirelessly transmitted to the reception unit.

In a further method step d), the preferably cartographic output or display of the geographic position of the person to be localized occurs at the reception unit.

The advantage of the method according to the present invention is thus particularly that in this way the actual ascertainment of the position of a transmission unit and/or the person to be localized no longer has to be performed complexly and usually with inadequate precision by the reception unit, but rather the position ascertainment may be performed by the transmission unit itself. The position ascertained by the transmission unit at high precision solely has to still be transmitted via wireless communication to the reception unit and displayed there.

A further advantage of the method according to the present invention is accordingly also that no connection to the reception unit is still necessary for the purpose of position determination and/or during the position determination. The position ascertained by the transmission unit of the person to be localized solely has to be transmitted subsequently in a suitable way wirelessly to the reception unit.

Therefore, the method according to the present invention is primarily also independent of the wireless communication pathway used between transmission unit and reception unit, as long as this communication pathway allows timely and secure transmission of the position data between transmission unit and reception unit.

According to an especially preferred embodiment of the method according to the present invention, however, the wireless communication between transmission unit and reception unit in method steps b) and c) is performed as a data exchange via SMS.

The communication between transmission unit and reception unit via exchange of SMS messages is particularly distinguished by cost-effectiveness and reliability. An advantage of using existing mobile wireless networks having the SMS transmission pathways provided therein is also that the transmission power of the transmission unit may remain low—independently of the distance between transmission unit and reception unit—because thanks to the mobile wireless networks, which are always divided into radio cells, a direct wireless link between transmission unit and reception unit is not necessary.

According to a further embodiment of the present invention, the ascertainment of the current geographic position of the transmission unit may alternatively also be performed by localizing via the particular GSM radio cell in which the transmission unit is currently located. This is advantageous because in this way approximate location determination of the transmission unit may still be performed if satellite locating is not possible in the case of shadowing of the locating satellites.

According to a further, especially preferred embodiment of the method according to the present invention, in case of impermissible manipulations on the transmission unit, for example, in the event of opening of the housing or removal of the transmission unit from the clothing, an emergency call is placed. This embodiment of the method offers especially high protection in regard to manipulation security, and vandalism or kidnapping protection.

In the following, the present invention is explained in greater detail on the basis of a drawing, which merely illustrates one exemplary embodiment.

### BRIEF DESCRIPTION OF THE DRAWINGS

The single FIGURE shows an embodiment of a localizing configuration according to the present invention in a schematic illustration which is not to scale.

### DETAILED DESCRIPTION OF THE INVENTION

An embodiment of a configuration for localizing individuals according to the present invention is illustrated very schematically in the FIGURE.

Firstly, the reception unit 1, which particularly comprises a housing 2 and a display screen 3, may be seen. Furthermore, the reception unit 1 is also equipped with an on-off switch 4. In addition to the reception unit, three transmission units 5, 6, 7 may also be seen in the FIGURE.

The transmission units 5, 6, 7 are implemented in the form of a sphere or the form of a symbolized soccer ball in the exemplary embodiment shown, and each comprise a fastening device, designed as a key fob 8, 9, for connection in particular to the clothing of the person to be localized.

Reception unit 1 and transmission units 5, 6, 7 have a wireless communication link to one another. However, the connection between reception unit 1 and transmission units 5, 6, 7 is not produced directly via radio, but rather preferably via a GSM mobile wireless network, and especially via the mobile wireless service SMS therein.

In relation to a direct wireless link, the communication between reception unit 1 and transmission units 5, 6, 7 via GSM/SMS primarily has the decisive advantage of distance independence. Furthermore, the communication via exchange of SMS messages is cost-effective and especially reliable, because SMS messages may be delivered—time-delayed—by the mobile wireless operator even if the receiver is not reachable for a short time.

The typical sequence for localizing a person—for example, for checking the location of a child by the parents—runs using the configuration according to the present invention and/or the method according to the present invention as follows:

Firstly, the operator, i.e., the parent in the present case, switches on the reception unit 1 using the on-off switch. In view of simple operation, the embodiment of the reception unit 1 illustrated has no further hardware operating elements in addition to the on-off switch. Rather, the entire operation is performed via the touch-sensitive display screen 3, implemented as a touchscreen.

After turning on the reception unit 1, a button or an input element having the title “find person” or the like appears on the display screen. The operator touches this input element on the touchscreen of the reception unit 1. Subsequently, a list of the transmission units 2 registered in the reception unit 1 appears, in the present example, i.e., a list of buttons and/or input elements comprising the two names “Paul” and “Lisa”.

The operator touches the input element having the name of the child whose location is to be established; in the present case, this is the input element identified by “Paul”. Pressing the input element “Paul” triggers the localization of the transmission unit 5, which Paul carries with him.

For this purpose, the reception unit 1 transmits the command for localization to the transmission unit 5 of Paul via SMS. The transmission units 5, 6, 7 are preferably set up in such a way that they automatically determine their particular position permanently and at regular intervals via GPS or Galileo and store it for some time. However, the position determination may—for example, for the purpose of saving energy—also only be performed in case of a corresponding request by the reception unit 1.

In any case, however, the transmission unit 5 of Paul transmits its own instantaneous position back to the reception unit 1 as a result of the SMS position request placed by the reception unit 1 and received by the transmission unit 5.

This transmission back of the instantaneous position of the transmission unit 5 also again occurs via an SMS message, which is sent by the transmission unit 5 via the mobile wireless network to the reception unit 1.

The reception unit 1 then analyzes the brief message sent by the transmission unit 5 of Paul and finally displays the transmitted geographic position of Paul on the installed display screen 3 of the reception unit 1, as shown in the FIGURE.

In the exemplary embodiment shown, besides the transmission unit 5 of Paul, a further transmission unit 6 is logged on with the reception unit 1. This further transmission unit 6 is assigned in the exemplary embodiment to a further child named Lisa, for example, the sister of Paul. Therefore, the parents may, with the aid of the reception unit 1, and/or with the aid of the localization configuration 1, 5, 6 according to the present invention, establish the instantaneous location of their children in an extremely simple and reliable way at any time.

If needed, further transmission units 7 etc. may be registered or logged on with the reception unit 1, so that further children or individuals may also be localized.

In the exemplary embodiment shown, the transmission units 5, 6, 7 are designed as compact spherical and/or ball-like key fobs. Thanks to the SIM cards already installed and thanks to the ability to charge the installed battery inductively, the transmission units 5, 6, 7 may be hermetically sealed at the factory, and are thus extremely robust and safe from manipulation. Additional manipulation security may be achieved by implementing the key fobs 8, 9 for attaching the transmission units 5, 6, 7 to the clothing in such a way that upon detachment of the connection between transmission unit and clothing, an alarm signal is sent to the reception unit 1.

To avoid unneeded sending of an alarm signal in the event of removal of the transmission unit 5, 6, 7 from the clothing for the purpose of charging the transmission unit 5, 6, 7, furthermore, alarming does not occur if the transmission unit is placed in the associated inductive charging station directly after removal from the clothing.

As a result, it is thus clear that the possibilities for geographic localization of individuals are expanded and simultaneously decisively simplified by the present invention. In particular, the present invention allows both high precision in localization, and also position ascertainment over arbitrary distances, the method according to the present invention and the device according to the present invention, which is producible cost-effectively, also being able to be used easily by lay people and/or by end-users.

The present invention may therefore advantageously be used particularly—but in no way exclusively—for improving the security of families with children, for example, during the phase in which the children begin to move independently in a city and/or at greater distances from the family home.

What is claimed:

1. A configuration for localization of the geographic position of at least one person, the configuration comprising a battery-powered transmission unit (5, 6, 7) connectable to the person, as well as a reception unit (1) for displaying the geographic position of the person,
characterized in that
the transmission unit (5, 6, 7) comprises a satellite locating receiver and is connectable via wireless communication to the reception unit (1).

2. The localization configuration according to claim 1,
characterized in that
the wireless communication between transmission unit (5, 6, 7) and reception unit (1) is implemented as a data exchange via SMS or as a GPRS data exchange for storing the geographic position on a server.

3. The localization configuration according to claim 1,
characterized in that
transmission unit (5, 6, 7) and/or reception unit (1) contains a standardized GSM or CDMA module.

4. The localization configuration according to claim 1,
characterized in that
the transmission unit (5, 6, 7) contains a standardized GPS module.

5. The localization configuration according to claim 1,
characterized in that
the transmission unit (5, 6, 7) is additionally set up for locating via the particular GSM radio cell.

6. The localization configuration according to claim 1,
characterized in that
the transmission unit (5, 6, 7) has a housing which is to be opened not at all or only using special tools.

7. The localization configuration according to claim 1,
characterized in that
the transmission unit (5, 6, 7) is set up to place an emergency call in case of opening of the housing.

8. The localization configuration according to claim 1,
characterized in that
the transmission unit (5, 6, 7) has a permanently integrated user identification.

9. The localization configuration according to claim 1,
characterized in that
the transmission unit (5, 6, 7) and/or the reception unit (1) has an induction apparatus for contactless charging of a battery of the transmission unit (5, 6, 7) or reception unit (1).

10. The localization configuration according to claim 1,
characterized in that
the transmission unit (5, 6, 7) may be visibly identified clearly using the name of the person to be localized.

11. The localization configuration according to claim 1,
characterized in that
the transmission unit (5, 6, 7) is set up for wireless communication exclusively with the assigned reception unit (1).

12. The localization configuration according to claim 1,
characterized in that
the transmission unit (5, 6, 7) is set up for wireless communication exclusively with the assigned reception unit (1) and with one further reception unit (1).

13. The localization configuration according to claim 1,
characterized in that
the transmission unit (5, 6, 7) and/or the reception unit (1) is a mobile telephone.

14. The localization configuration according to claim 1,
characterized in that
the transmission unit (5, 6, 7) is removably connected to a fastener (9) for connecting the transmission unit (5, 6, 7), particularly to clothing of the person to be localized.

15. The localization configuration according to claim 14,
characterized in that
the transmission unit (5, 6, 7) is set up to place an emergency call in case of removal from the fastener (9).

16. The localization configuration according to claim 1,
characterized by
a transponder unit directly connectable to the body of the person to be localized, the transponder unit being able to be connected via wireless communication to the transmission unit (5, 6, 7), and the transmission unit (5, 6, 7) being set up to place an emergency call in case of interruption of the communication between transponder unit and transmission unit (5, 6, 7).

17. The localization configuration according to claim 16,
characterized in that
the transponder unit may be introduced into the body of the person and/or is unremovably connectable to the body of the person.

18. A method for ascertaining the geographic position of at least one person using a transmission unit (5, 6, 7) connectable to the person, and using a reception unit (1) for displaying the geographic position of the person, the transmission unit (5, 6, 7) comprising a satellite locating receiver, the method having the following method steps:
a) command input for localizing the person on the reception unit (1);
b) wireless transmission of the localization command to the transmission unit (5, 6, 7) of the person;
c) wireless transmission of the current geographic position of the transmission unit (5, 6, 7) by the transmission unit (5, 6, 7) to the reception unit (1); and
d) display of the geographic position of the person on the reception unit (1).

19. The method according to claim 18,
characterized in that
the wireless communication between transmission unit (5, 6, 7) and reception unit (1) in the method steps b) and/or c) is implemented as a data exchange via SMS or as a GPRS data exchange for storing the geographic position on a server.

20. The method according to claim 18,
characterized in that
the ascertainment of the current geographic position of the transmission unit (5, 6, 7) additionally and/or alternatively occurs using localizing via the particular GSM radio cell.

21. The method according to claim 18,
characterized in that
in case of impermissible manipulations on the transmission unit (5, 6, 7), an emergency call is placed by the transmission unit (5, 6, 7).
